(19) United States
(12) Patent Application Publication
(10) Pub. No.: US 2026/0094315 A1
(43) Pub. Date: Apr. 2, 2026

(54) OPTICAL LEAK SENSOR OUTPUT AGGREGATION AND VISUALIZATION

(71) Applicant: DELL PRODUCTS L.P., Round Rock, TX (US)

(72) Inventors: Sandor Farkas, Round Rock, TX (US); Michael Stumpf, Cedar Park, TX (US)

(21) Appl. No.: 18/901,156

(22) Filed: Sep. 30, 2024

(51) Int. Cl. G06T 11/00; G01N 21/90

(52) U.S. Cl. CPC G06T 11/10; G01N 21/90; G01N 2201/12; G06T 2200/24; G06T 2210/12

(57) ABSTRACT

An electronic apparatus for aggregating and visualizing output generated by an optical leak sensor (OLS) of an information handling system includes a sensor interface, a mapping module, and an image generator. The sensor interface is configured to communicatively couple with the OLS to obtain the output generated by the OLS. The output is generated by the OLS in response to the OLS absorbing light reflected from an object illuminated by the OLS. The mapping module operatively couples with the sensor interface and is configured to map the output generated by the OLS to color coordinates on a predetermined color map. The color coordinates correspond to the color of the light absorbed by the OLS. The image generator operatively couples with the mapping module and is configured to generate a visual image of the color map with the color coordinates mapped thereto for display with a graphical user interface.

### FIELD OF THE DISCLOSURE

The present disclosure generally relates to information handling systems, and more particularly relates to optical sensors for detecting a liquid coolant leak in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An electronic apparatus may be utilized to aggregate and visualize an output generated by an optical leak sensor (OLS) of an information handling system The electronic apparatus includes a sensor interface, a mapping module, and an image generator. The sensor interface may be configured to communicatively couple with the OLS to obtain the output generated by the OLS. The output may be generated by the OLS in response to the OLS absorbing light reflected from an object illuminated by the OLS. The mapping module operatively couples with the sensor interface to map the output generated by the OLS to color coordinates on a predetermined color map. The color coordinates correspond to the color of the light absorbed by the OLS. The image generator operatively couples with the mapping module to generate a visual image of the color map with the color coordinates mapped thereto for display with a graphical user interface.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a front view an optical leak sensor according to an embodiment of the present disclosure;

FIG. 2 illustrates an example of the output generated by the optical leak sensor of FIG. 1 according to an embodiment of the present disclosure;

FIG. 3 is a block diagram of an electronic apparatus for aggregating and visualizing the output of the optical leak sensor of FIG. 1 according to an embodiment of the present disclosure;

FIG. 4 illustrates an example graphical user interface (GUI) generated according to an embodiment of the present disclosure;

FIG. 5 illustrates another example GUI generated according to an embodiment of the present disclosure.

FIG. 6 illustrates yet another example GUI generated according to an embodiment of the present disclosure;

FIG. 7 is a flow diagram of a method for visualizing with a GUI the output generated by an OLS of an information handling system according to an embodiment of the present disclosure;

FIG. 8 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Certain types of information handling systems, including desktops, laptops, servers, and the like, are sufficiently sized to permit cooling the systems using a liquid cooling apparatus or assembly. A liquid cooling apparatus may include a pump, tubing, heat exchanger, coolant port, one or more CPU cold plates, one or more GPU cold plates, a memory heatsink, and fan. Operatively, the pump circulates a coolant such as water or other liquid (e.g., water plus additives) through the tubing and heat exchanger to the components of the information handling system, including memory, one or more CPUs and/or one or more GPU, as well as other components. The pump circulates coolant-absorbing heat from the components and cooling the components via the cold plates-in a closed loop within the housing of the information handling system. Liquid cooling offers advantages over other types of cooling. Thus, as the processing power of information handling systems continues to increase, the use of liquid cooling is expected to become more common.

Notwithstanding the advantages of liquid cooling, there is the possibility that one or more components of the liquid cooling system may develop leaks over time due to vibration, thermal cycles, aging, misalignment of heat exchangers or cold plates, or the like. Any leak that exposes the components of the information handling system to liquid can cause corrosion or damage to the circuitry within the system's housing. In certain arrangements, a leak occurring in one information handling system also may damage one or more nearby information handling systems if the systems are sufficiently close to one another. For example, a leak may occur in one of multiple servers stacked on a vertical rack (an increasingly common configuration). If the leak is not detected early enough, the coolant may spill out of one server and adversely affect one or more servers below it on the vertical rack.

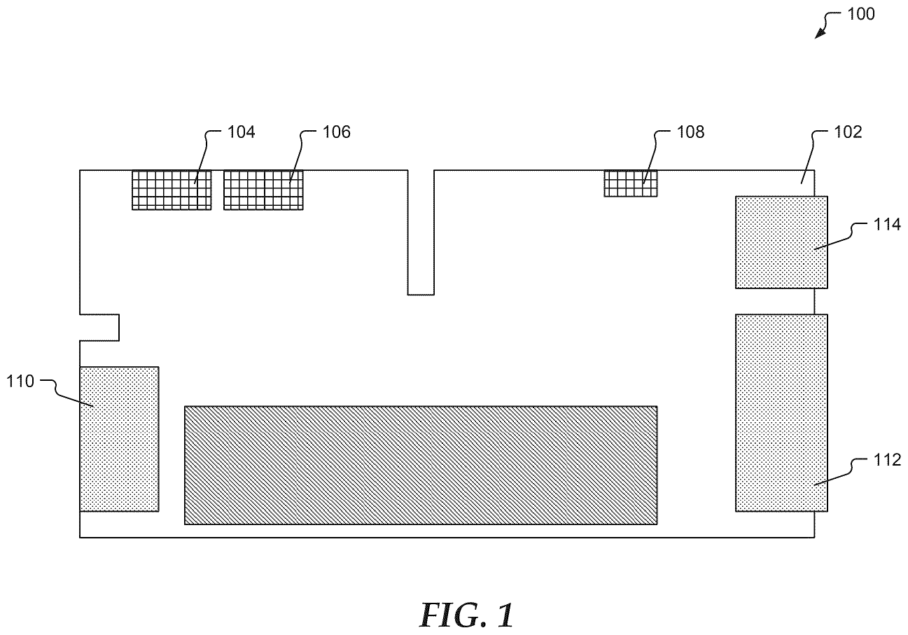

FIG. 1 illustrates optical leak sensor (OLS) 100 for detecting a potential leak within the chassis or housing of an information handling system. OLS 100 illustratively includes circuit board 102, one or more light sources 104 and 106, color sensor 108, downstream communications circuity 110, and upstream communications circuitry 112. OLS 100, in certain arrangements, may be integrated into the mainboard of an information handling system. In other arrangements, OLS 100 may be a stand-alone device that connects internally to an information handling system, for example by connecting to an internal partition, side region, cover, or other part of the information handling system. Accordingly, in some embodiments, OLS 100 includes one or more connectors 114.

Operatively, OLS 100 detects a potential leak based on information conveyed by the nature of the light detected by color sensor 108 when light emitted by light source 104 or 106 is reflected to the color sensor. In certain embodiments, light sources 104 and 106 are light emitting diodes (LEDs). The light emitted by light sources 104 and 106 may have a specific wavelength or may form a spectrum of light having different frequencies and corresponding wavelengths. In certain embodiments, the emitted light is specifically ultraviolet (UV) light. The coolant of a liquid cooling apparatus or assembly used by the information handling system may be infused with a fluorescent dye whose fluorescence is detectable by color sensor 108. Light sources 104 and 106, in certain embodiments, are configured to emit pulses of light in a predetermined pattern. In other embodiments, light sources 104 and 106 may emit a constant light emission.

Color sensor 108 may be an array of photodiodes that are sensitive to different wavelengths of light and that are configured to determine color based on the ratio of reflected RGB light. In accordance with some embodiments, color sensor 108 can include RGB filters that capture the intensity of the primary colors, such that the combined data determines the color of the light. In other embodiments, color sensor 108 includes multiple, stacked photodetectors in which each layer is sensitive to a specific color. Color sensor 108, according to yet other embodiments, includes plasmonic grating that differentiates between light wavelengths and directs specific light colors into specific photodetectors without filtering.

As configured, color sensor 108 may absorb light across a color spectrum in response to the light being reflected from an object within the chassis of an information handling system. The object, for example, may be a central processing unit (CPU), graphics processing unit (GPU), memory, power supply unit, dual inline memory module (DIMM) latch, internal wall of the chassis, or other component of the information handling system. The components may be part of a printed circuit board with expansion capabilities that makes up a motherboard or mainboard of the information handling system. The object may be an extraneous or foreign object. Of specific interest is an object formed by a collection of liquid coolant leaked from a liquid cooling apparatus or subsystem of the information handling system.

OLS 100, by virtue of sensing color of the reflected light offers advantages over conventional detectors such as a green-optimized photodiode (PD), which typically requires high gain circuitry given that it must operate with respect to signals whose amplitudes are usually in a nano-range level. High gain, however, tends to cause saturation if the absorbed, reflected light is too strong and can also amplify noise, thus requiring hardware and/or firmware filtering. The PD only senses light intensity of one range of wavelengths centered around 560 nm and is thus usually not able to identify an actual color. Accordingly, there is a likelihood of PD ultraviolet (UV) leakage. UV leakage is unwanted UV light that reaches the PD. The PD sees part of the UV leakage as incoming light because the PD's UV rejection is not perfect. Fluorescence from extraneous objects within the chassis may give rise to a false positive that erroneously indicates a coolant leak. By contrast, OLS 100 as a color-based sensing apparatus, uses the color spectrum to offer higher dynamic range, higher sensitivity, enhanced linearity and better noise rejection. Specifically, the expanded spectral components obtained by OLS 100 provide an added source of information for identifying objects within the information handling system based on the color of the objects, especially an object formed by a collection of liquid coolant infused with a dye that fluoresces in response to light of a specific type (e.g., UV light).

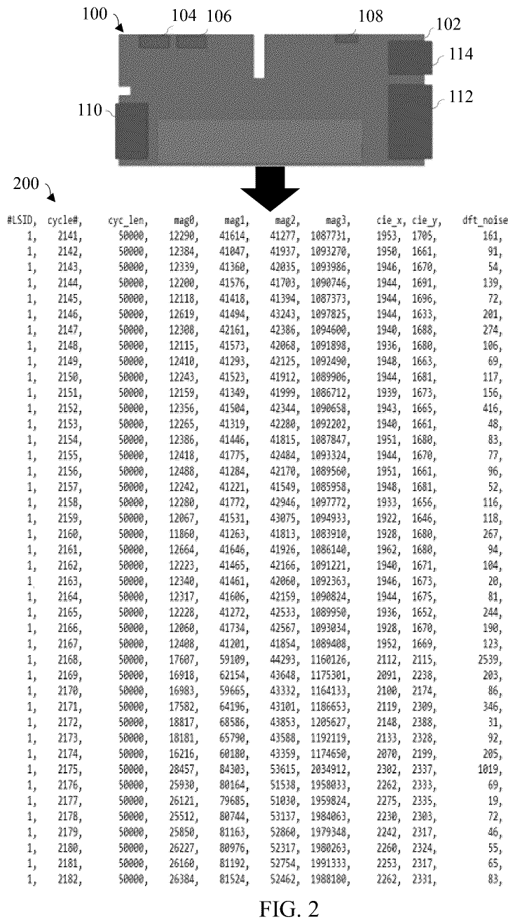

Although the color-based light sensing by OLS 100 offers definite advantages, it nonetheless poses unique challenges to fine-tuning the OLS, especially given that the OLS may perform differently in different environments. Adding to the challenges is the complexity of the output of OLS 100. FIG. 2 illustrates an exemplary output 200 of OLS 100. Output 200 is generated by OLS 100's sampling electrical signals generated by color sensor 108 in response to the sensor's absorbing light reflected from objects illuminated by light sources 104 and 106. In some embodiments, for example, the output of OLS 100 may be discrete Fourier transform (DFT) data in which a sequence of complex numbers represents the frequency domain of the sampled electrical signals. Given the complexity of the output of OLS 100, it may be difficult to precisely identify which color data corresponds to a potential leak and which does not. The difficulty adds to the challenge of a design-in of OLS 100 for a specific information handling system because the OLS does not operate the same in every environment. It is likewise difficult to evaluate OLS 100 if the OLS is part of a network of multiple optical leak sensors. Much like a picture that is worth a thousand words, an aggregation and visualization of the OLS output offers distinct advantages for fine-tuning the OLS and monitoring its output. Visualization conceptually conveys color information without having to sort and meticulously read the raw output, an example of which is output 200 of OLS 100.

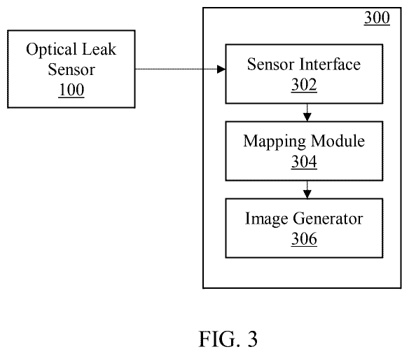

FIG. 3 illustrates an electronic apparatus 300 according to an embodiment of the present disclosure. Electronic apparatus 300 is configured to aggregate and visualize output of an OLS such as OLS 100 of FIG. 1. Aggregation and visualization of the OLS output by electronic apparatus 300 may enable or permit fine-tuning the OLS during the design and development phases. Once deployed, the OLS can be monitored, and its performance analyzed by electronic apparatus 300. Electronic apparatus 300 can analyze OLS performance in relation to specific events, such as the actual occurrence of a coolant leak within the housing or chassis of an information handling system.

Electronic apparatus 300 illustratively includes sensor interface 302, mapping module, 304, and image generator 306. Sensor interface 302, for example, may be a communications interface such as the Inter-Integrated Circuit (I²C), Serial Data Interface SDI-12, Universal Asynchronous Receiver/Transmitter (UART), or other type of sensor interface. In certain embodiments, mapping module 304 and/or image generator 306 may be implemented in processor-executable code that executes on one or more processors of an application-specific or general-purpose information handling system. Mapping module 304 and/or image generator 306 in other embodiments may be implemented in hardwired circuitry. In still other embodiments, mapping module 304 and/or image generator 306 may be implemented in a combination of processor-executable code and hardwired circuitry.

Operatively, sensor interface 302 is configured to communicatively couple with an OLS, such as OLS 100, to obtain output generated by the OLS in response to the OLS absorbing light reflected from an object illuminated by the OLS. Mapping module 304 operatively couples with sensor interface 302 and is configured to map the output generated by the OLS to color coordinates on a predetermined color map. In certain embodiments, the predetermined color map is the well-known Commission Internationale de l'Éclairage, or CIE, color map. The color coordinates mapped by mapping module 304 correspond to and represent the color of the light absorbed by the OLS. The color may be a primary color or a mixture of primary colors. Image generator 306 operatively couples with mapping module 304 and is configured to generate a visual image of the color map. The visual image of the color map shows the color coordinates, or points, that are mapped to the color map by mapping module 304. The visual image can be displayed with a GUI on a monitor or screen of an information handling system or device.

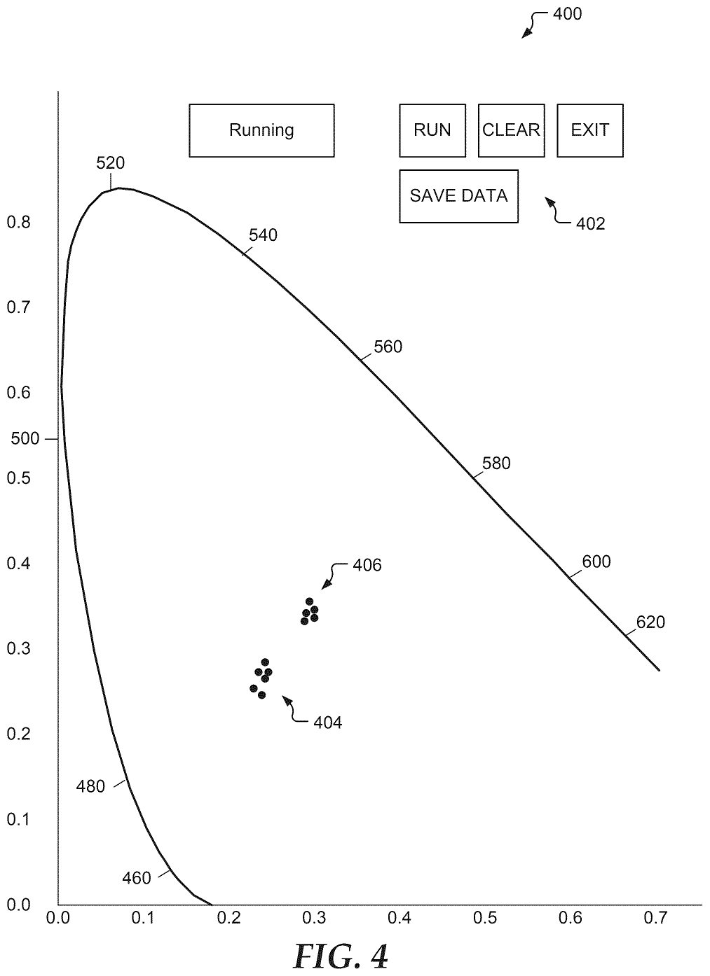

FIG. 4 illustrates an example GUI displaying color map 400 along with a group of interactive GUI icons 402, including command icons (run, save data, clear, exit) for facilitating user control. Color map 400 is illustratively a CIE color map. Illustratively, groups 404 and 406 of distinct color coordinates are shown, each group of color coordinates mapped to color map 400 by mapping module 304.

Mapping module 304, in certain embodiments, may cluster the color coordinates into two or more distinct sets based on a predetermined criterion. The predetermined criterion may be the nature of the object illuminated by the OLS, given that the color coordinates correspond to the color of light that is reflected from the specific object illuminated. Illuminated objects may include, for example, a collection of liquid coolant leaked from a liquid cooling assembly of an information handling system. Thus, the color coordinates may correspond to the fluorescence of a dye added to the liquid coolant used in the liquid cooling assembly. The color coordinates, for example, may correspond to residual light (e.g., UV light) emitted by the OLS and reflected from a surface of the housing of the information handling system. Color coordinates may correspond to light reflected by one or more extraneous objects (e.g., bug) within the housing, for example. Some color components, for example, correspond to light reflected from one or more objects normally included within the housing (e.g., a CPU). Accordingly, the predetermined criterion may be the color reflected from a specific type of object.

Another predetermined criterion is a quality associated with the color coordinates, specifically a signal quality. The OLS output is based on sampling electrical signals generated by the OLS in response to the light absorbed. Accordingly, in certain embodiments, mapping module 304 may cluster, or otherwise identify, color coordinates based on the quality of the electrical signals sampled. The signals on which a portion of the output is derived may be normal. Other signals, however, may be characterized by a low signal-to-noise ratio making the output less certain or reliable. If, for example, the OLS outputs DFT data, then the predetermined criterion may be the level DFT noise (e.g., quantization noise, truncation noise, additive noise, or aliasing) which is due to unwanted fluctuations that may occur in performing the transformation.

If mapping module 304 is configured to cluster the color coordinates into two or more distinct sets based on a predetermined criterion, then image generator 306 may be configured to generate the visual image showing each of the two or more distinct sets. Each set may be enclosed within its own visual boundary.

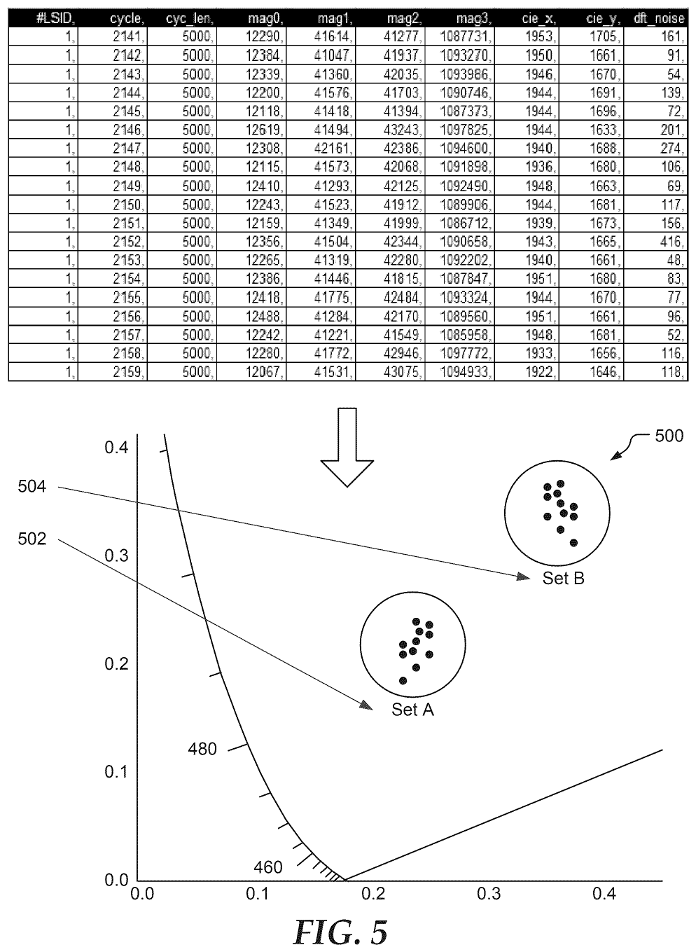

FIG. 5 illustrates an example GUI displaying color map 500 in which color coordinates are clustered into distinct sets 502 and 504 according to a predetermined criteria (e.g., level of DFT noise). Sets 502 and 504 each include color coordinates mapped by mapping module 304, which maps OLS output 506 to color map 500. Each set, as shown, is enclosed within its own visual boundary. In certain embodiments, mapping module 304 is configured to generate an identifying tag for each of two or more distinct sets, and image generator 306 is configured to generate the visual image showing the identifying tag of each distinct set. Illustratively, in FIG. 5, sets 502 and 504 are generically tagged “set A” and “set B,” respectively. The tags, however, may be more descriptive, indicating certain characteristics of the color coordinates enclosed within each of the visual boundaries to which each tag pertains. Using the interactive capabilities of the GUI, in accordance with some embodiments, a user may annotate the two or more distinct sets. Image generator 306 visually displays the annotations, which in various arrangements include additional visual tags or user-added notations, for example.

In certain embodiments, mapping module 304 may identify and cluster color coordinates corresponding to a color of light indicating an actual or potential coolant leak. The color may be the color occurring when a dye infused in the coolant fluoresces in response to illumination by the OLS. Correspondingly, in accordance with the embodiments, image generator 306 is configured to generate the visual image by showing the color coordinates corresponding to the color of light indicating a coolant leak within a bounding box or other boundary.

Mapping module 304 may be further configured to categorize the color coordinates corresponding to the color of light indicating a coolant leak into different categories. The categories may be based on a predetermined criterion, such as the quality of the sensor-generated signals that are sampled by the OLS and that determine the OLS output. For example, mapping module 304 may categorize the color coordinates based on the amplitude or signal-to-noise ratio of the sampled signals from which the color coordinates are determined. In certain embodiments, mapping module 304 discards color coordinates derived from signals whose quality is less than a predetermined threshold. For example, mapping module 304 may discard color coordinates derived from signals having an amplitude or signal-to-noise ratio that is less than a predetermined level. Mapping module 34, in other embodiments, identifies and flags color coordinates derived from signals whose quality is less than a predetermined threshold image generator. Image generator 306 may be configured to generate a visual image in which the identified color coordinates are visually distinguishable from other color coordinates corresponding to the color of light indicating a coolant leak.

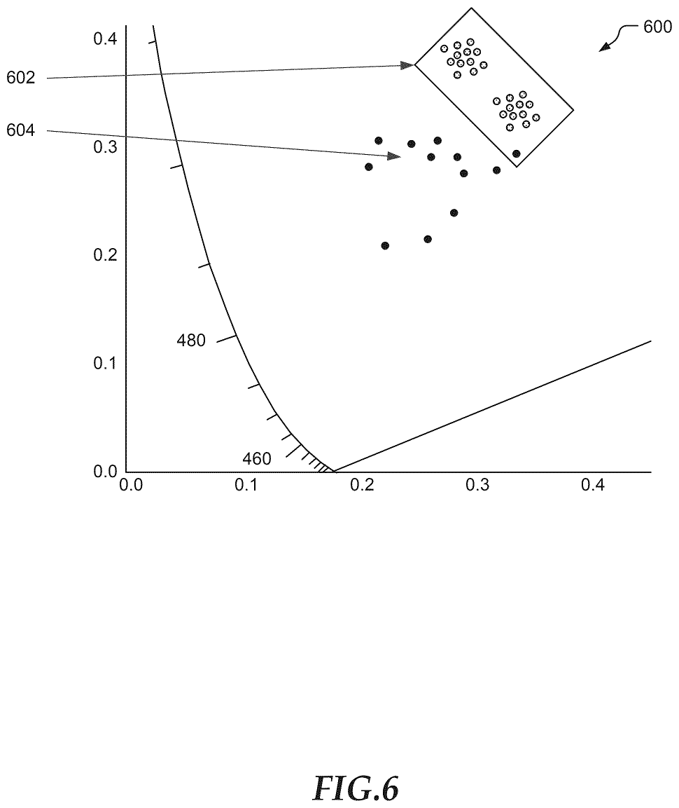

FIG. 6 illustrates an example GUI displaying color map 600 in which color coordinates corresponding to the color of light indicating a coolant leak are enclosed in bounding box 602. Moreover, image generator 306 generates color map 600 so that color coordinates 604—determined by mapping module 304 to have been derived from signals whose quality is less than a predetermined threshold—are visually distinguishable. Image generator 306 generates the GUI-displayed color map such that color coordinates 604 appear dark in contrast other color coordinates, which appear bright. In various embodiments, color coordinates may be visually distinguishable using other visual devices. For example, color coordinates may be shown using different shapes for differently categorized color coordinates displayed in the visual image of the color map.

In certain embodiments, electronic apparatus 300 may obtain output generated by the OLS in real time. Receiving the OLS output via sensor interface 302 in real time, mapping module 304 likewise may map the output to color coordinates on a predetermined color map in real time. Image generator 306 similarly may generate a visual image of the color map showing the color coordinates in real time. The visual image may be displayed in real time with a GUI.

With embodiments in which electronic apparatus 300 is implemented in information handling system having one or more processors and a memory, for example, the output that is received from the OLS via sensor interface 302 may be saved in the memory. Color coordinates and/or the images generated by image generator 306 of color maps to which the color coordinates are mapped by mapping module 304 also may be saved in the memory. Color coordinates and/or color maps to which they are mapped and saved in memory also may be exported to another information handling system or a device. Previously generated images of color maps to which color coordinates are mapped over time and saved, may be played back with a GUI. Using GUI command icons, a user may accelerate the playback and/or adjust the timescale as desired. The user conversely may stop the rendering of the images to more closely analyze changes in colors in response to events such as a sudden occurrence of a coolant leak. Visualization and aggregation of the OLS output greatly facilitates the analysis in a way that is not possible were the user forced to perform the analysis based only on reading the raw output of the OLS. For example, visualization of the OLS output may make more easily discernible the colors sensed by the OLS in response to the occurrence of a coolant leak, providing a user with a visual conception of what happens when such a leak occurs.

The user, in certain embodiments, may use the GUI command icons to annotate the color map displayed and/or to group different images of the color map generated over time. The annotations and/or groupings may further facilitate a visual analysis of an event such as a coolant leak.

In some embodiments, electronic apparatus 300 may be implemented in a device, such as a handheld device, having a processor or circuitry for performing the mapping and generating an image but not having sufficient memory for storing the OLS output. Nonetheless, electronic apparatus may have a communications port to link to a memory to obtain the OLS output for processing and image generation on a screen of the device.

Electronic apparatus 300 may obtain output from more than one OLS. For example, output may be obtained by electronic apparatus 300 from an OLS network or a chain of OLSs. The chain may include one or more OLSs that are coupled with one or more sensor “ropes” for detecting liquids, or the chain may include one or more rope-only devices. Electronic apparatus 300, in certain embodiments, may be configured to treat the output from multiple OLSs like the scope channels of an oscilloscope. That is, mapping module 304 may be configured to map the output generated by each different device to color coordinates on a color map, and image generator 306 may be configured to generate the visual image of the color map such that the color coordinates of each of the multiple devices is visually distinguishable from color coordinates of other of the multiple devices (e.g., OLSs, OLSs plus sensor ropes, rope-only devices). For example, in some embodiments, image generator 306 may generate a color map in which the color coordinates are displayed as differently color points, the color depending on the device that generated the output from which the color coordinates were mapped by mapping module 304. In other embodiments, different types of representations of color coordinates may be used by image generator 306 to visually differentiate the color coordinates.

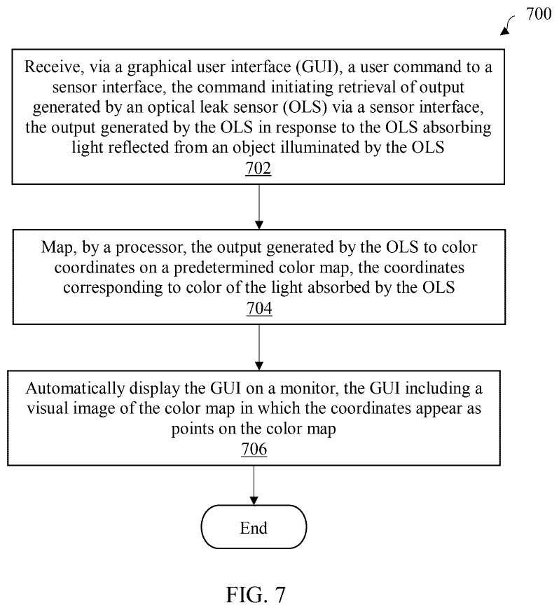

FIG. 7 is a flow diagram of example method 700 for visualizing with a GUI the output generated by an OLS of an information handling system according to embodiment of the present disclosure. It will be readily appreciated that not every method step set forth in this flow diagram is always necessary, and that certain steps of method 700 may be combined, performed simultaneously, performed in a different order, or omitted altogether, without varying from the scope of the disclosure. Method 700 may be performed by an information handling system or other electronic apparatus, such as electronic apparatus 300, having one or more processors and/or circuitry for performing the method.

At block 702, a user command to a sensor interface is received via the GUI. The command initiates retrieval via the sensor interface of the output generated by the OLS. The output is generated by the OLS in response to the OLS absorbing light reflected from an object illuminated by the OLS.

At block 704, a processor maps the output generated by the OLS to color coordinates on a predetermined color map. The color coordinates mapped to the color map correspond to the color of the light absorbed by the OLS. The color may be a primary color or mix of primary colors, such as that of the fluorescence of a dye when illuminated by light (e.g., UV light). The dye may be infused in coolant circulated within the chassis or housing of an information handling system cooled by a liquid cooling assembly. The fluorescence occurs when the coolant leaks and is illuminated by the OLS.

At block 706, a monitor displays the GUI. As displayed, the GUI includes a visual image of the color map. The color map shows the color coordinates positioned on the color map.

Method 700, in certain embodiments, includes the processor clustering the color coordinates into two or more distinct sets. The sets are generated based on a predetermined criterion. Method 700 may include generating that visual image to show each of the two or more sets enclosed within a visual boundary. In some embodiments, method 700 includes generating with the processor an identifying tag for each of the two or more distinct sets, and the visual image being generated with the identifying tag of each distinct set adjacent to the visual boundary of the distinct set. The output is generated by the OLS based on sampling electrical signals generated in response to the light absorbed. Accordingly, in certain embodiments, the predetermined criterion for clustering the color coordinates is the quality of the electrical signals sampled.

In certain embodiments, method 700 includes clustering color coordinates that correspond to light indicating a likely coolant leak into a set and generating the visual image to show the set within a bounding box or other visual boundary. Method 700 may include categorizing the color coordinates corresponding to light indicating a likely coolant leak. Categorizing may be based on a predetermined criterion. Method 700, accordingly, may include generating the visual image such that color coordinates in each category are visually distinguishable from color coordinates in one or more other categories. With output generated by the OLS sampling signals generated in response to the light absorbed by the OLS, the predetermined criterion for categorizing the color coordinates corresponding to light indicating a likely coolant leak may be the quality of the signals sampled. In some embodiments, method 700 includes either discarding or visually distinguishing those color coordinates that correspond to light indicating a likely coolant leak and that are derived from signals whose quality is less than a predetermined threshold (e.g., minimum amplitude or signal-to-noise ratio).

If output is generated by more than one OLS, method 700 may include mapping the output generated by each OLS to color coordinates and generating the visual image of the color map such that color coordinates of each OLS are visually distinguishable from the color coordinates of the others

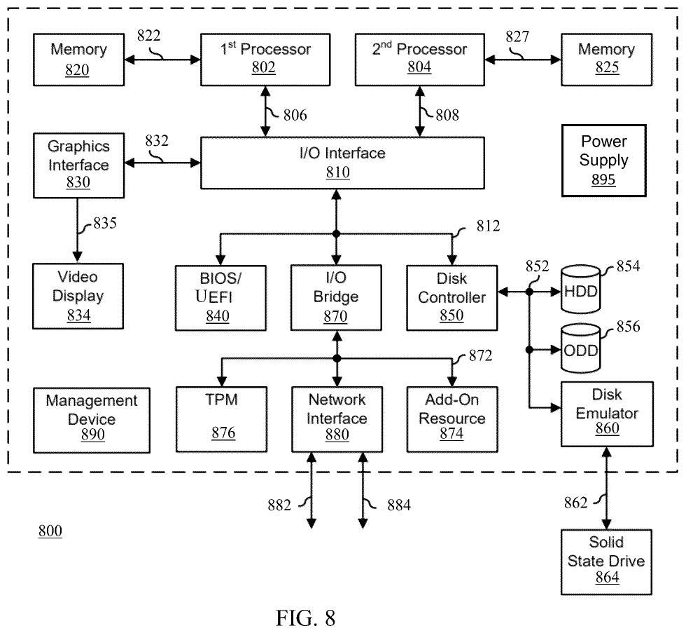

FIG. 8 shows a generalized embodiment of an information handling system 800 according to an embodiment of the present disclosure. Information handling system 800 may be substantially similar to electronic apparatus 300 described in the context of FIGS. 3-6. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 800 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 800 can include processing resources for executing machine-executable code, such as a central processing unit (CPU), a programmable logic array (PLA), an embedded device such as a System-on-a-Chip (SoC), or other control logic hardware. Information handling system 800 can also include one or more computer-readable medium for storing machine-executable code, such as software or data. Additional components of information handling system 800 can include one or more storage devices that can store machine-executable code, one or more communications ports for communicating with external devices, and various input and output (I/O) devices, such as a keyboard, a mouse, and a video display. Information handling system 800 can also include one or more buses operable to transmit information between the various hardware components.

Information handling system 800 can include devices or modules that embody one or more of the devices or modules described below and operates to perform one or more of the methods described below. Information handling system 800 includes a processors 802 and 804, an input/output (I/O) interface 810, memories 820 and 825, a graphics interface 830, a basic input and output system/universal extensible firmware interface (BIOS/UEFI) module 840, a disk controller 850, a hard disk drive (HDD) 854, an optical disk drive (ODD) 856, a disk emulator 860 connected to an external solid state drive (SSD) 864, an I/O bridge 870, one or more add-on resources 874, a trusted platform module (TPM) 876, a network interface 880, a management device 890, and a power supply 895. Processors 802 and 804, I/O interface 810, memory 820, graphics interface 830, BIOS/UEFI module 840, disk controller 850, HDD 854, ODD 856, disk emulator 860, SSD 864, I/O bridge 870, add-on resources 874, TPM 876, and network interface 880 operate together to provide a host environment of information handling system 800 that operates to provide the data processing functionality of the information handling system. The host environment operates to execute machine-executable code, including platform BIOS/UEFI code, device firmware, operating system code, applications, programs, and the like, to perform the data processing tasks associated with information handling system 800.

In the host environment, processor 802 is connected to I/O interface 810 via processor interface 806, and processor 804 is connected to the I/O interface via processor interface 808. Memory 820 is connected to processor 802 via a memory interface 822. Memory 825 is connected to processor 804 via a memory interface 827. Graphics interface 830 is connected to I/O interface 810 via a graphics interface 832 and provides a video display output 836 to a video display 834. In a particular embodiment, information handling system 800 includes separate memories that are dedicated to each of processors 802 and 804 via separate memory interfaces. An example of memories 820 and 830 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 840, disk controller 850, and I/O bridge 870 are connected to I/O interface 810 via an I/O channel 812. An example of I/O channel 812 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 810 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 840 includes BIOS/UEFI code operable to detect resources within information handling system 800, to provide drivers for the resources, initialize the resources, and access the resources. BIOS/UEFI module 840 includes code that operates to detect resources within information handling system 800, to provide drivers for the resources, to initialize the resources, and to access the resources.

Disk controller 850 includes a disk interface 852 that connects the disk controller to HDD 854, to ODD 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits SSD 864 to be connected to information handling system 800 via an external interface 862. An example of external interface 862 includes a USB interface, an IEEE 4394 (Firewire) interface, a proprietary interface, or a combination thereof. Alternatively, solid-state drive 864 can be disposed within information handling system 800.

I/O bridge 870 includes a peripheral interface 872 that connects the I/O bridge to add-on resource 874, to TPM 876, and to network interface 880. Peripheral interface 872 can be the same type of interface as I/O channel 812 or can be a different type of interface. As such, I/O bridge 870 extends the capacity of I/O channel 812 when peripheral interface 872 and the I/O channel are of the same type, and the I/O bridge translates information from a format suitable to the I/O channel to a format suitable to the peripheral channel 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on separate circuit board or add-in card disposed within information handling system 800, a device that is external to the information handling system, or a combination thereof.

Network interface 880 represents a NIC disposed within information handling system 800, on a main circuit board of the information handling system, integrated onto another component such as I/O interface 810, in another suitable location, or a combination thereof. Network interface device 880 includes network channels 882 and 884 that provide interfaces to devices that are external to information handling system 800. In a particular embodiment, network channels 882 and 884 are of a different type than peripheral channel 872 and network interface 880 translates information from a format suitable to the peripheral channel to a format suitable to external devices. An example of network channels 882 and 884 includes InfiniBand channels, Fibre Channel channels, Gigabit Ethernet channels, proprietary channel architectures, or a combination thereof. Network channels 882 and 884 can be connected to external network resources (not illustrated). The network resource can include another information handling system, a data storage system, another network, a grid management system, another suitable resource, or a combination thereof.

Management device 890 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 800. In particular, management device 890 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 800, such as system cooling fans and power supplies. Management device 890 can include a network connection to an external management system, and the management device can communicate with the management system to report status information for information handling system 800, to receive BIOS/UEFI or system firmware updates, or to perform other task for managing and controlling the operation of information handling system 800.

Management device 890 can operate off a separate power plane from the components of the host environment so that the management device receives power to manage information handling system 800 when the information handling system is otherwise shut down. An example of management device 890 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 890 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

That which is claimed is:

1. An electronic apparatus for aggregating and visualizing an output generated by an optical leak sensor (OLS) of an information handling system, the electronic apparatus comprising:
a sensor interface configured to communicatively couple with the OLS to obtain the output generated by the OLS, wherein the output is generated in response to the OLS absorbing light reflected from an object illuminated by the OLS;
a mapping module operatively coupled to the sensor interface, wherein the mapping module maps the output generated by the OLS to color coordinates on a predetermined color map, wherein the color coordinates correspond to a color of the light absorbed by the OLS; and
an image generator operatively coupled with the mapping module, wherein the image generator is configured to generate a visual image of the predetermined color map with the color coordinates mapped thereto for display with a graphical user interface.

2. The electronic apparatus of claim 1, wherein the mapping module is further configured to cluster the color coordinates into two or more distinct sets based on a predetermined criterion, and wherein the image generator is further configured to generate the visual image showing each of the two or more distinct sets enclosed within a visual boundary.

3. The electronic apparatus of claim 2, wherein the mapping module is further configured to generate an identifying tag for each of the two or more distinct sets, and wherein the image generator is further configured to generate the visual image showing the identifying tag of each distinct set.

4. The electronic apparatus of claim 2, wherein the output is based on sampling electrical signals generated by the OLS in response to the light absorbed, and wherein the predetermined criterion is a quality of the sampled electrical signals.

5. The electronic apparatus of claim 1, wherein the mapping module is further configured to cluster color coordinates corresponding to a color of light indicating a coolant leak, and wherein the image generator is further configured to generate the visual image showing the color coordinates corresponding to the color of light indicating a coolant leak within a bounding box.

6. The electronic apparatus of claim 5, wherein the mapping module is further configured to categorize the color coordinates corresponding to the color of light indicating the coolant leak into different categories according to a predetermined criterion, and wherein the image generator is further configured to generate the visual image such that color coordinates in each category are visually distinguisable from other color coordinates.

7. The electronic apparatus of claim 6, wherein the output is based on sampling signals generated by the OLS in response to the light absorbed, and wherein the predetermined criterion is a quality of the sampled electrical signals.

8. The electronic apparatus of claim 7, wherein the mapping module is configured to discard or visually distinguish color coordinates derived from signals whose quality is less than a predetermined threshold.

9. The electronic apparatus of claim 1, wherein the OLS is one of a plurality of optical leak sensors, wherein the mapping module is configured to map the output generated by each of the plurality of optical leak sensors to color coordinates, and wherein the image generator is configured to generate the visual image of the predetermined color map such that color coordinates mapped from outputs of each of the plurality optical leak sensors are visually distinguishable from color coordinates mapped from output of other of the plurality of optical leak sensors.

10. A method of visualizing with a graphical user interface (GUI) output generated by an optical leak sensor (OLS) of an information handling system, the method comprising:
receiving, via the GUI, a user command to a sensor interface, the user command initiating retrieval of the output generated by the OLS via the sensor interface, wherein the output is generated by the OLS in response to the OLS absorbing light reflected from an object illuminated by the OLS;
mapping, by a processor, the output generated by the OLS to color coordinates on a predetermined color map, wherein the color coordinates correspond to color of the light absorbed by the OLS; and
automatically displaying the GUI on a monitor, wherein the GUI includes a visual image of the predetermined color map that shows the color coordinates mapped thereto.

11. The method of claim 10, further comprising:
clustering the color coordinates into two or more distinct sets based on a predetermined criterion; and
generating the visual image showing each of the two or more distinct sets enclosed within a visual boundary.

12. The method of claim 11, further comprising:
generating an identifying tag for each of the two or more distinct sets; and
generating the visual image with the identifying tag of each distinct set adjacent to the visual boundary of the distinct set.

13. The method of claim 11, wherein the output is based on sampling electrical signals generated by the OLS in response to the light absorbed, and wherein the predetermined criterion is a quality of the electrical signals sampled.

14. The method of claim 10, further comprising:
clustering color coordinates corresponding to light indicating a likely coolant leak into a set; and
generating the visual image showing the set within a bounding box.

15. The method of claim 14, further comprising:
categorizing the color coordinates corresponding to light indicating a coolant leak based on a predetermined criterion; and
generating the visual image such that color coordinates in each category are visually distinguisable from other color coordinates.

16. The method of claim 15, wherein the output is based on sampling signals generated by the OLS in response to the light absorbed, and wherein the predetermined criterion is a quality of the sampled electrical signals.

17. The method of claim 16, further comprising:
discarding or visually distinguishing color coordinates derived from signals whose quality is less than a predetermined threshold.

18. The method of claim 10, wherein the OLS is one of a plurality of optical leak sensors, and further comprising:
mapping the output generated by each of the plurality of optical leak sensors to color coordinates; and
generating the visual image of the predetermined color map such that color coordinates mapped from outputs of each of the plurality optical leak sensors are visually distinguishable from color coordinates mapped from output of other of the plurality of optical leak sensors.

19. An information handling system, comprising:
a monitor;
one or more processors operatively coupled with the monitor; and
a memory operatively coupled to the one or more processors, wherein the memory stores program instructions executable by the one or more processors to:
receive an output generated by an optical leak sensor (OLS), wherein the output is generated by the OLS in response to the OLS absorbing light reflected from an object illuminated by the OLS;
map the output generated by the OLS to color coordinates on a predetermined color map, wherein the color coordinates correspond to color of the light absorbed by the OLS; and
display a graphical user interface (GUI) on the monitor, wherein the GUI includes a visual image of the predetermined color map that shows the color coordinates.

20. The information handling system of claim 19, wherein the output is received, mapped, and displayed with the GUI in real time.
